(19) United States
(12) Patent Application Publication
(10) Pub. No.: US 2024/0307834 A1
(43) Pub. Date: Sep. 19, 2024

(54) SYSTEMS AND METHODS FOR PRODUCING EMULSIONS USING ULTRASONIC ROTATING MAGNETIC FIELD

(71) Applicants: Sung-Gook LEE, Bucheon-si (KR); Jin-Gook BOK, Bucheon-si (KR); SHENG QIAU FANG CO., LTD., Gangseo-Gu, Seoul (KR); PUREPLANTE BIOSCIENCE INC., Toronto (CA)

(72) Inventors: Sung-Gook LEE, Bucheon-si (KR); Jin-Gook BOK, Bucheon-si (KR)

(21) Appl. No.: 18/272,413

(22) PCT Filed: Jan. 19, 2022
(86) PCT No.: PCT/CA2022/050074

§ 371 Date: Jul. 14, 2023

(30) Foreign Application Priority Data
Jan. 19, 2021 (KR) 10-2021-0007449

(51) Int. Cl. B01F 23/411; B01F 23/41; B01F 31/80; B01F 33/451; B01F 33/81

(52) U.S. Cl. CPC B01F 23/4111; B01F 23/4105; B01F 31/84; B01F 33/451; B01F 33/811

(57) ABSTRACT

The present disclosure relates to systems and methods for producing emulsions, and more specifically to methods that use ultrasonic rotating magnetic fields for producing emulsions. The systems and/or methods described herein can be used to produce emulsions without the use of surfactant.

### CROSS-REFERENCE TO RELATED APPLICATION

This disclosure claims the benefit of Korean Appl. No. 10-2021-0007449, filed Jan. 19, 2021, the contents of which are incorporated herein by reference in their entirety.

### FIELD

The present disclosure related generally to systems and methods for producing emulsions, and more specifically to methods that use ultrasonic rotating magnetic fields for producing emulsions.

### BACKGROUND

An emulsion refers to a state when two or more immiscible components are mixed, wherein one or more components are dispersed in another component, for example as fine particles. Milk is an example of an emulsion composed of water, fat, and other components.

Emulsions may be made of two different immiscible liquids, which form different types of emulsions depending on the solvent and solute. Different emulsions can be made from the same immiscible liquids, depending on which component acts as the solvent and which component acts as the solute.

The liquid that acts as a solvent is referred to as a dispersion medium or a continuous phase, and the liquid that acts as a solute is referred to as a dispersed phase.

For an emulsion of water and oil, for example, an ‘oil-in-water (O/W)’ emulsion and a ‘water-in-oil (W/O)’ emulsion are possible. These emulsions are characterized by the volume ratio of the two phases or the type of emulsifier.

Such emulsions appear cloudy because light scattering occurs at the boundary between the continuous phase and the dispersed phase. When the scattering occurs uniformly, the emulsion appears white.

It is extremely rare that an emulsion is spontaneously formed. Typically, an emulsion is formed by applying energy through an external mechanical means, such as shaking, stirring, homogenizing, or exposing to ultrasonic waves. Surfactants are also typically used. For example, Korean Patent Application No. 10-2020-7001821 (Name: cosmetic composition comprising two specific cationic surfactants and silicone emulsion, and cosmetic treatment method/2018.06.21.) describes using one or more cationic surfactants in cosmetic compositions, in particular a hair product composition.

However, emulsions emulsified through such conventional surfactants can be environmentally unfriendly and unhealthy for human consumption.

All objects have a natural frequency. Resonance refers to the phenomenon of vibrating with an increased amplitude at a specific frequency that occurs when the frequency of a periodically applied force is equal or close to a natural frequency of the object on which it acts, and that specific frequency is called a ‘resonant frequency’. A resonant frequency can transmit large amplitude and energy even under the action of a small force.

Vibration can appear in mechanics, acoustics, optics, etc. In particular, resonance can occur in electrical and engineering vibration systems.

In electrical resonance, a capacitor and an inductor exchange energy with each other, and have a characteristic in which the impedance changes significantly in the vicinity of the ‘resonant frequency’.

Electrical resonance is used in technologies such as magnetic resonance imaging (MRI), which is widely used in hospitals. In MRI, a strong magnetic field is applied to the human body. Hydrogen atoms of the body absorb a specific frequency energy of external electromagnetic waves resulted from resonance. Depending on the condition of the cells in the body, the hydrogen atoms return to an energetically lower state at different times, which can be measured to determine whether or not the cells are diseased or not.

There remains a need in the art for new methods and systems to generate emulsions without the use of surfactants.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

The present invention has been proposed to solve the problems of the prior art and to provide an emulsion processing system using ultrasonic rotating magnetic fields. The system can be used to emulsify two or more immiscible components by passing the components through one or more rotating magnetic fields generated by high voltages to which ultrasonic frequency is applied. Hydrogen atoms of water particles in the components vibrate violently at the resonance frequency, generating thermal energy and forming activated reduced hydrogen. Using this resulting activated reduced hydrogen, an emulsion is produced. The emulsions produced are stable and of high-quality. Since no separate surfactants are required, the resulting emulsions are eco-friendly and health-friendly.

In accordance with one broad aspect of this disclosure, there is provided an emulsion treatment system, the system comprising:
a movement path of the object to be treated (for example two or more immiscible components) nested inside and through a main body of the system;
a magnetic field generating unit that creates one or more ultrasonic rotating magnetic fields along the movement path with power from a power control unit that receives power and controls processes;
and a high voltage generating unit that supplies a high voltage from the power control unit to the magnetic field generating unit.

In some embodiments, the above-mentioned magnetic field generating unit is (a) radially located with respect to the ultrasonic rotating magnetic field (i.e., the magnetic field generating unit may at least partially surround the ultrasonic rotating magnetic field); (b) electronically connected to the high voltage generating unit; and (c) made with one or more core modules composed of multiple cores creating one or more magnetic fields powered by the power control unit. The above-mentioned individual cores of the core module are supplied with power at a sequentially alternating cycle to form an ultrasonic rotating magnetic field along the movement path. In some embodiments, two or more core modules are arranged in series along the path of the water in intervals, so the object to be treated passes through more than one ultrasonic rotating magnetic field.

In some embodiments, the system further comprises an emulsion tank, which is spatially connected through a connecting pipe to the movement path of the object to be treated, to store the treated object and to stir to emulsify it.

Also, this disclosure is characterized by certain embodiments wherein kinetic energy is applied to the object to forcibly transfer the object from the main body of the system to the emulsion tank.

When the object to be treated passes through the ultrasonic rotating magnetic fields formed by the magnetic field generating unit, the hydrogen atoms of water particles in the object absorb the resonance frequency of the ultrasonic rotating magnetic field and violently vibrate, generate thermal energy, and absorb the energy of the resonance frequency. The absorbed energy is maintained without being reduced over a long period of time until it returns to its original state and emulsions are created.

The emulsion processing systems described herein can be used, for example, to emulsify extracts extracted from plants beneficial to the human body. The systems and methods disclosed herein can have the effect of providing eco-friendly and health-friendly extract emulsions by forming and providing stable and high-quality extract emulsions without consuming surfactants.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a schematic illustration showing an emulsion processing system according to an embodiment of the present invention.

FIG. 2 is a schematic cross-sectional view showing an emulsion processing system according to the present embodiment.

FIG. 3 is a schematic illustration showing the use state of the emulsion processing system according to the present embodiment.

FIG. 4 is a top view showing the working state of the magnetic field generating unit constituting the emulsion processing system according to the present embodiment.

FIG. 5 is a top view showing the working state of the magnetic field generating unit constituting the emulsion processing system according to the present embodiment.

FIG. 6 is a top view showing the working state of the magnetic field generating unit constituting the emulsion processing system according to the present embodiment.

FIG. 7 is a schematic exemplary view showing the flow of the object through ultrasonic rotating magnetic fields along the path in the emulsion processing system according to the present embodiment.

FIG. 8 is a schematic illustration showing the control state of the emulsion processing system according to the present embodiment.

FIG. 9 is an image of emulsions generated by the system disclosed herein.

FIG. 10 is graph showing an example of size distribution of particles generated by the system disclosed herein. In this example, Z-average was 1590 d.nm and Pdl was 0.233.

### DETAILED DESCRIPTION

Various systems and methods are described below to provide an example of an embodiment of each claimed invention. No embodiment described below limits any claimed invention and any claimed invention may cover systems and methods that differ from those described below. The claimed inventions are not limited to systems and methods having all of the features of any one system or method described below or to features common to multiple or all of the systems and methods described below. It is possible that a system or method described below is not an embodiment of any claimed invention. Any invention disclosed in a system or method described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following is a description of a method for producing an emulsion which may be used by itself or in combination with one or more of the other features disclosed herein including the use of any of the features of the systems and/or and any of the methods disclosed herein.

All publications, patent applications, patents, figures and other references mentioned herein are expressly incorporated by reference in their entirety.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

The term “consisting” and its derivatives, as used herein, are intended to be closed ended terms that specify the presence of stated features, elements, components, groups, integers, and/or steps, and also exclude the presence of other unstated features, elements, components, groups, integers and/or steps.

Further, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

More specifically, the term “about” means plus or minus 0.1 to 20%, 5-20%, 10-20%, 10%-15%, preferably 5-10%, most preferably about 5% of the number to which reference is being made.

As used in this specification and the appended claims, the singular forms “a”, “an” and “the” include plural references unless the content clearly dictates otherwise. Thus, for example, a composition containing “a compound” includes a mixture of two or more compounds. It should also be noted that the term “or” is generally employed in its sense including “and/or” unless the content clearly dictates otherwise.

The definitions and embodiments described in particular sections are intended to be applicable to other embodiments herein described for which they are suitable as would be understood by a person skilled in the art.

The recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about.”

Further, the definitions and embodiments described in particular sections are intended to be applicable to other embodiments herein described for which they are suitable as would be under-stood by a person skilled in the art. For example, in the following passages, different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Although any methods and materials similar or equivalent to those described herein can also be used in the practice or testing of the present disclosure, examples of methods and materials are now described.

Embodiments of the present invention may be modified in various forms, and the scope of the present invention should not be construed as being limited to the embodiments described in detail below. This example is provided to explain the present invention more completely to those of ordinary skill in the art. Accordingly, the shape of the elements in the drawings may be exaggerated to emphasize a clearer description. It should be noted that in each drawing, the same member is shown with the same reference numerals in some cases. Detailed descriptions of well-known functions and configurations determined to unnecessarily obscure the gist of the present invention will be omitted.

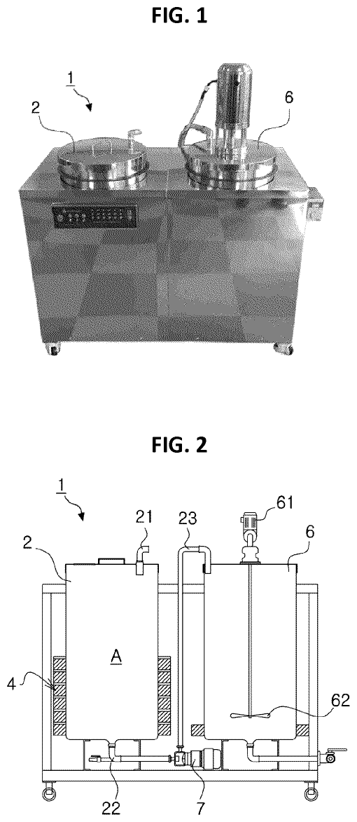

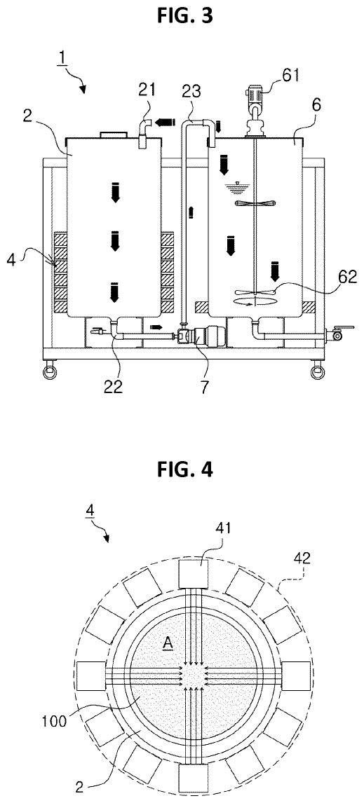

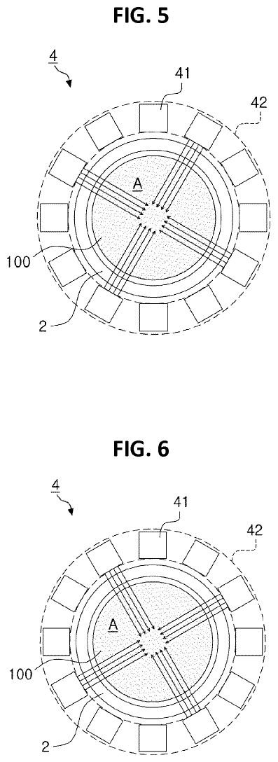

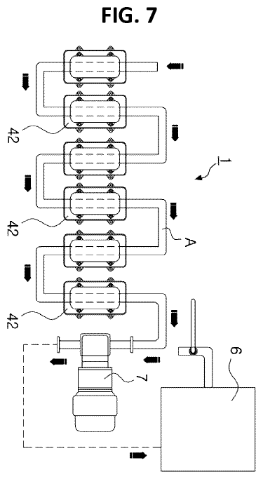

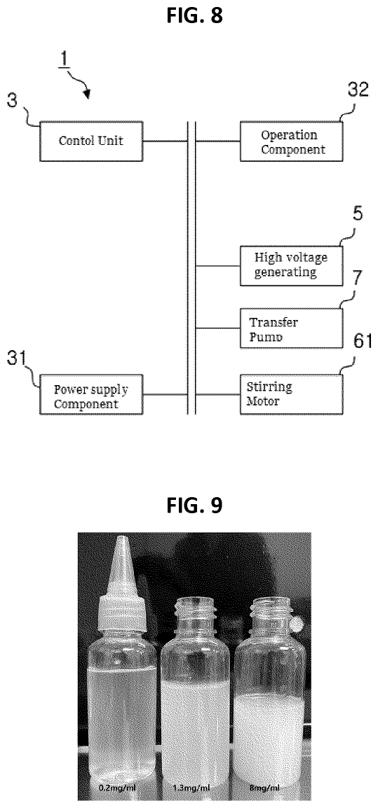

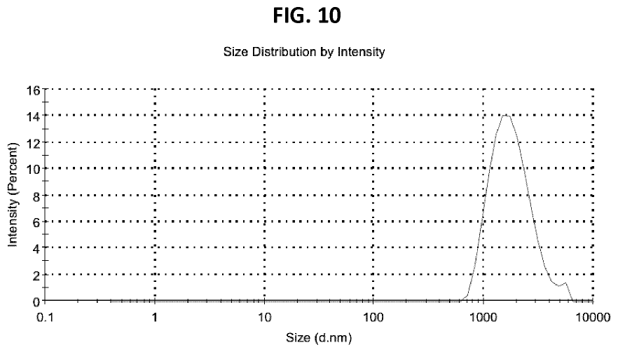

FIGS. 1 to 8 show embodiments of an emulsion treatment system (1) that uses ultrasonic rotating magnetic fields to emulsify components of interest (also referred to here as an “object to be treated”). The components of interest optionally comprise two or more immiscible components. At least one of the immiscible components is optionally a liquid such as water. An example of two or more immiscible components are oil and water. The object to be treated can be for example, an extract (such as a plant extract) with at least two immiscible components such as essential oils.

The system applies an ultrasonic rotating magnetic field to the object to be treated (100) within the system, causing to hydrogen atoms contained in the object to absorb specific frequency energy through resonance.

The emulsion treatment system (1) that uses ultrasonic rotating magnetic fields according to the present disclosure comprises:
a path (A) where the object (100) to be treated moves in the treatment main frame (2);
a magnetic field generating unit (4) configured to create one or more ultrasonic rotating magnetic fields along the movement path (A), the magnetic field generating unit (4) is controlled by a control unit (3) which is powered by a power supply component (31);
a high voltage generating unit (5) that supplies high voltage to the magnetic field generating unit (4) using power received from the control unit (3).

When the object (100) passes through the path (A), high voltages are supplied to the magnetic field generating unit (4) through the high voltage generating unit (5) to form one or more ultrasonic rotating magnetic fields in the path (A). The hydrogen atoms of the water particles in the object (100) absorb the resonance frequency energy created by the ultrasonic rotating magnetic fields and generate thermal energy by vibrating violently to ultrasonic waves. As a result, hydrogen gas (H₂) from the aqueous component of the object (100) is formed and interrupts surface tension between the immiscible liquids.

Without being bound by theory, it is understood that the hydrogen H₂ is generated from a water component of the object to be treated, and this generated hydrogen helps to form emulsions by creating nano-bubbles. Since nano-bubbles are so small in size, they effectively disrupt surface tensions of oil-and-water layers. These processes happen in the path (A) of movement. Stirring can occur continuously in the emulsion tank (6), which stabilizes the emulsion and prevents coagulation.

In an embodiment, the treatment main frame (2) above comprises a supply pipe (21) through which the object (100) is supplied and a discharge pipe (22) through which the object (100) is discharged to the outside. The object (100) may be supplied from the outside and discharged to outside after being treated.

The high voltage generating unit (5) may comprise a ‘high voltage generating structure’ that generates a 6 kV-32 kV high voltage through the control of the control unit (3), so to produce frequency between 50 Hz to 100 kHz in the magnetic field generating unit (4) The ‘high voltage generating structure’ can be any suitable structure made according to conventional technology and can be appropriately applied.

In one embodiment, the magnetic field generating unit (4) can be arranged radially with respect to the ultrasonic rotating magnetic field with respect to the ultrasonic rotating magnetic field along the path (A). In one embodiment, the magnetic field generating unit (4) can be electrically connected to the high voltage generating unit (5). In one embodiment, the magnetic field generating unit (4) can comprise one or more core modules (42) comprising multiple cores (41) that create one or more magnetic fields with power supplied through the control unit (3).

The control unit (3) supplies power in a sequentially alternating cycle to each of the cores (41) in the core module (42) and an ultrasonic rotating magnetic field is created along the path (A) of the object. In a sequentially alternating cycle or pulses, power is first supplied to one pair of cores (41) that are directly opposed to each other in the core module (42). As shown in FIGS. 4 to 6, power is supplied to another pair of cores (41) in the core module (42) subsequently. The process of sequentially supplying power to pairs of opposing cores (41) in the core module (42) is repeated in a single direction.

The core (41) receives power from the control unit (3), for example at a frequency of 50 hz-100 Khz to form an ultrasonic rotating magnetic field along path (A).

In the high voltage generating unit (4), the power may be adjusted to 6 kV-32 kV by the control unit (3) and supplied to the core (41) to produce reduction of hydrogen.

The operation of the emulsion treatment system (1) according to an embodiment is described as follows.

First, when the user operates a separate operation component (32) and supplies the power selected through the control of the control unit (3) to the high voltage generating unit (5), the high voltage generating unit (5) converts to a high voltage and supplies to each of the core modules (42).

When a high voltage is applied to the core modules (42), a specific voltage for a specifically set frequencies to each of the cores (41) constituting the core modules (42) is applied. Then the rotating magnetic force lines are generated to form each ultrasonic rotating magnetic field over the path (A).

At this time, hydrogen atoms of the water particles in the object (100) passing through the path (A) absorb resonance frequency energy while passing through the ultrasonic rotating magnetic field and are reduced to hydrogen gas, and the object (100) is emulsified through the generated reduced hydrogen.

In some embodiments, the magnetic field generating unit (4) comprises one core module (42). In some embodiments, the magnetic field generating unit (4) comprises two or more core modules (42) arranged in series with a distance between each of them over the path (A), so that the object (100) passes through multiple ultrasonic rotating magnetic fields formed.

That is, as the hydrogen atoms in the object (100) are sequentially and continuously activated while passing through multiple ultrasonic rotating magnetic fields, conversion to reduced hydrogen is properly performed and the quality and stability of reduced hydrogen is maximized.

As a result, the reduced hydrogen can maintain high quality and stability for a long time.

In one embodiment, the emulsion treatment system (1) can further comprise a connecting pipe between the path (A) and an emulsion tank (6). After the activation of hydrogen particles of water in the object (100), the object can be stored and stirred to further emulsify the object (100) and to stabilize the emulsion in the emulsion tank (6).

In one embodiment, the object (100) is treated to have reduced hydrogen through the treatment main frame (2) and is transferred to the emulsion tank (6) to be further emulsified.

In one embodiment, a transfer pump (7) can be installed between the path (A) and the emulsion tank (6) to selectively transfer the object (100) from the path (A) to the emulsion tank (6) by applying kinetic energy to the object (100).

In other words, in an embodiment, the connection pipe (23), connecting between the discharge pipe (22) of the treatment main frame (2) and the emulsion tank (6), can be connected to the transfer pump (7) and selectively transfer the object (100) to the emulsion tank (6).

Accordingly, depending on the user's selection, the emulsion treatment operation of the object (100) is performed, and the emulsion processing efficiency can be improved.

In another embodiment, a stirring impeller (62) can be installed in the emulsion tank (6) to further emulsify the object (100) by rotational forces created by the stirring motor (61) powered and controlled under the control unit (3).

In other words, through the stirring motor (61) in the emulsion tank (6), the emulsion quality can be improved by evenly stirring the immiscible components of the object (100). In addition the stirring motor (61) stabilizes the emulsion through additional agitation.

In another embodiment, the emulsion treatment sytem (1) can comprise two or more core modules (42) arranged in an interval along the path (A) and on the outer surface of the treatment main frame (2). As a result, multiple ultrasonic rotating magnetic fields may be formed in the treatment main frame (2) with gaps between each of fields.

The two or more core modules (42) on the outer surface of the treatment main frame (2) in the above can be arranged according to the user's application and selection. In one embodiment, two or more core modules (42) is between 2 to 8. In one embodiment, two or more core modules (42) is 6.

The reduction of hydrogen and emulsification of the object (100) to be treated can be maximized by sequentially and repeatedly performing the reduced hydrogen activation.

In another embodiment, the emulsion treatment system (1) can further comprise an auxiliary magnetic field generating unit (8) in the emulsion tank (6) which receives power supplied by the control unit (3) through the high voltage generating unit (5) and creates ultrasonic rotating magnetic fields.

The effectiveness of emulsification can be maximized by providing a continuous environment for hydrogen activation by the auxiliary magnetic field generating unit (8). While the immiscible components including the water particles activated by the reduced hydrogen in the object (100) are evenly stirred in the emulsion tank (6), hydrogen atoms of the object (100) can continue to absorb the resonance frequency through the ultrasonic rotating magnetic field generated by the auxiliary magnetic field generating unit (8) and generate heat energy by vibrating violently to ultrasonic waves.

In one embodiment, the auxiliary magnetic field generating unit (8) can be located around the emulsion tank (6), radially positioned with respect to the ultrasonic rotating magnetic field, electrically connected to the high voltage generating unit (5), supplied with power through the control unit (3), and comprises one or more core modules (42) made up of multiple cores (41). The operation of core modules (42) is as described above.

The embodiment of the present invention described above is merely exemplary, and those of ordinary skill in the art to which the present invention pertains will appreciate that various modifications and equivalent other embodiments are possible. Therefore, it will be well understood that the present invention is not limited to the forms recited in the above detailed description. Also, the true technical protection scope of the present invention should be determined by the technical spirit of the appended claims. It is also to be understood that the present invention includes all modifications, equivalents and substitutions falling within the intension and scope of the invention as defined by the appended claims.

### LEGEND OF THE SYMBOLS

1: The emulsion treatment apparatus
   100: The object
2: treatment main frame
   21: supply pipe
   22: discharge pipe
   23: connection pipe
3: control unit
   31: power supply component
   32: operation component
4: magnetic field generating unit
   41: cores
   42: core module
5: high voltage generating unit
6: emulsion tank
   61: stirring motor
   62: stirring impeller
7: transfer pump
8: auxiliary magnetic field generating unit

Although any methods and materials similar or equivalent to those described herein can also be used in the practice or testing of the present disclosure, examples of methods and materials are now described.

### EXAMPLES

In the Examples below, oil and water were loaded into the treatment main frame (2). The system was powered on, and the magnetic field generating units (4) created ultrasonic magnetic field perpendicular to the path (A) at a frequency of 60 KHz˜80 KHz. After passing through the main frame (2), the emulsified liquid was transferred to the emulsion tank (6) through the transfer pump (7). In the emulsion tank (6), agitation was applied to stabilize emulsion state and prevent any possible coagulation while waiting for remaining emulsions from the main frame (2). After the treatment, immiscible liquids were stored in the emulsion tank (6) as an emulsion.

### Example 1

Emulsions Created without Emulsifiers

In this test, olive oil and water were mixed at 1:9 ratio (10% O/W) and emulsified using the system described herein.

Particle size of untreated sample, treated sample, and emulsifier-added sample (lecithin) was analyzed using the particle size analyzer, Malvern Zetasizer Pro Blue. The particle size analyzer provides a Z-average value, which is a measure of the average size of a particle size distribution. The lower the Z-average, the smaller the average particle size is.

### Results:

10% O/W treated samples vs. 10% O/W untreated samples

Results: Table 1 shows the z-average of treated samples (M=835, SD=148) and untreated samples (M=1514, SD=524). The particle size of treated samples was significantly smaller than untreated sample (t(6)=3.05, p<0.05).

TABLE 1
Z-average of treated vs non-treated samples

| | Z-Average |
|---|---|
| No treatment (1^{st} trial) | 1049 |
| Treated (1^{st} trial) | 723 |
| No treatment (2^{nd} trial) | 1980 |
| Treated (2^{nd} trial) | 947 |

No treatment: 10 ml olive oil + 90 ml DI water + no treatment
Treated: 10 ml olive oil + 90 ml DI water + treatment for 3 hrs

### Example 2

Treated Samples Compared to Sample Emulsified with Lecithin

In this test, olive oil and water were mixed at 1:9 ratio and emulsified using the system described herein. Particle size of untreated samples, treated samples, and lecithin-added samples was analyzed using the particle size analyzer, Malvem Zetasizer Pro Blue.

Table 2 shows that treated 10% O/W sample showed smaller average molecule size than 10% O/W sample with lecithin.

The z-average of 10% O/W treated sample (M=723, SD=128) was compared to the z-average of 10% O/W untreated sample with lecithin (M=821, SD=180). The treated sample had significantly smaller particle size than untreated sample with lecithin, t(4)=0.24, p<0.05.

The results show that it is possible to produce emulsion without using emulsifier, equal or better in quality.

TABLE 2
Z-average and PdI of treated and untreated samples

| | Z-average | PdI |
|---|---|---|
| O/W, no treatment | 1049 | 0.67 |
| O/W, treated | 723 | 0.71 |
| O/W, lecithin, no treatment | 821 | 0.93 |

O/W, no treatment: 10 ml olive oil + 90 ml DI water + no treatment
O/W, treatment: 10 ml olive oil + 90 ml DI water + treated
O/W, lecithin, no treatment: 10 ml olive oil + 90 ml DI water + 100 mg lecithin + no treatment

### Example 3

### Particle Size and Uniformity of the Emulsions

In this test, olive oil and water were mixed at 1:9 ratio. Particle size of untreated samples, samples treated using the system described herein and emulsifier-added samples (lecithin and combination of emulsifiers) were analyzed using the particle size analyzer, Malvern Zetasizer Pro Blue. The combination of emulsifiers used in this test consisted of: lecithin, ethanol triglycerides, polyxyl 40-hydroxyl castor oil, tween 20, span 80. (as per literature, Aswathanarayan, J. B.; Vittal, R. R. Nanoemulsions and Their Potential Applications in Food Industry. Frontiers in Sustainable Food Systems 2019, 3, 95.). Z-average (as described in Example 1) and polydispersity index (Pdl) were compared among the samples. Pdl reflects particle size distribution: a lower value indicates more uniformly sized and stable particles (Masarudin, Mas Jaffri et al. “Factors determining the stability, size distribution, and cellular accumulation of small, monodisperse chitosan nanoparticles as candidate vectors for anticancer drug delivery: application to the passive encapsulation of [(14)C]-doxorubicin.” Nanotechnology, science and applications vol. 8 67-80. 11 Dec. 2015, doi:10.2147/NSA.S91785).

The results of this test are shown in Table 3. The z-average of treated emulsifier combination samples (M=227, SD=2.90) was compared to the z-average of untreated emulsifier combination samples (M=240, SD=1.25). The treated samples had significantly smaller particle size than untreated samples, t(3)=0.007, p<0.05.

The z-average of treated lecithin samples (M=409, SD=114) was compared to the z-average of untreated lecithin sample (M=1262, SD=587). The treated samples had significantly smaller particle size than untreated sample, t(5)=0.02, p<0.05.

There was no significant difference in polydispersity index (Pdl) between treated emulsifier combination samples and untreated emulsifier combination samples.

The polydispersity index (Pdl) of treated lecithin samples (M=0.59, SD=0.18) was significantly smaller than the Pdl of untreated lecithin sample (M=0.85, SD=0.18), t(10)=0.03, p<0.05. This shows that the treated samples with lecithin were more evenly distributed and stable than untreated samples with lecithin.

TABLE 3
Z-average and PdI of treated and untreated
samples in the presence of emulsifiers

| Sample | Z-average | PdI |
|---|---|---|
| Comb | 239.7 | 0.136 |
| Comb | 241.1 | 0.141 |
| Comb | 238.6 | 0.142 |
| Comb + treatment | 230.3 | 0.182 |
| Comb + treatment | 227.5 | 0.183 |
| Comb + treatment | 224.5 | 0.143 |
| Lecithin | 2036 | 0.513 |
| Lecithin | 1941 | 0.823 |
| Lecithin | 1135 | 1 |
| Lecithin | 1023 | 0.853 |
| Lecithin | 676.2 | 0.925 |
| Lecithin | 763 | 1 |
| Lecithin + treatment | 314.1 | 0.441 |
| Lecithin + treatment | 296.4 | 0.466 |
| Lecithin + treatment | 317 | 0.447 |
| Lecithin + treatment | 542.7 | 0.667 |
| Lecithin + treatment | 531.8 | 0.603 |
| Lecithin + treatment | 453.6 | 0.89 |

Comb: 10 ml olive oil + 90 ml distilled water + combinations of emulsifiers as per literature
Comb + treatment: 10 ml olive oil + 90 ml distilled water + combinations of emulsifiers as per literature + treatment
Lecithin: 10 ml olive oil + 90 ml distilled water + 100 mg lecithin
Lecithin + treatment: 10 ml olive oil + 90 ml distilled water + 100 mg lecithin + treatment

While the present application has been described with reference to what are presently considered to be the preferred examples, it is to be understood that the application is not limited to the disclosed examples. To the contrary, the application is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

The scope of the claims should not be limited by the preferred embodiments and examples, but should be given the broadest interpretation consistent with the description as a whole.

1. A system for generating an emulsion comprising:
a movement path for an object to be treated to move;
a magnetic field generating unit to generate one or more ultrasonic rotating magnetic fields along the movement path;
a high voltage generating unit; and
a control unit configured to supply and manage power to the magnetic field generating unit and to the high voltage generating unit;
wherein the high voltage generating unit is connected to the magnetic field generating unit to boost voltage in the magnetic field generating unit; and
wherein the magnetic field generating unit is radially positioned with respect to the ultrasonic rotating magnetic field.

2. The system of claim 1,
wherein the magnetic field generating unit comprises one or more core modules along the movement path;
wherein each of the one or more core modules comprises one or more cores; and wherein the one or more cores is configured to receive power from the control unit.

3. The system of claim 2,
wherein the one or more core modules is at least two core modules; and
wherein the at least two core modules are arranged along the water movement path in series.

4. The system of claim 3, wherein the at least two core modules is between 2 and 8 modules.

5. The system of claim 3, wherein the at least two core modules is 6 modules.

6. The system of claim 1, further comprising an emulsion tank, wherein the emulsion tank comprises a connection pipe spatially connected to the movement path to receive the object after it has passed through the one or more ultrasonic rotating magnetic fields along the movement path.

7. The system of claim 6, wherein the emulsion tank comprises a stirring impeller.

8. The system of claim 6, wherein the emulsion tank further comprises an auxiliary magnetic field generating unit to generate one or more ultrasonic rotating magnetic fields; wherein the auxiliary magnetic field generating unit is configured to receive power from the control unit; and wherein the auxiliary magnetic field generating unit is connected to the high voltage generating unit.

9. A method of generating an emulsion, comprising passing two or more immiscible components through one or more ultrasonic rotating magnetic fields to obtain an emulsion.

10. The system of claim 4, wherein the at least two core modules is 6 modules.

11. The system of claim 7, wherein the emulsion tank further comprises an auxiliary magnetic field generating unit to generate one or more ultrasonic rotating magnetic fields; wherein the auxiliary magnetic field generating unit is configured to receive power from the control unit; and wherein the auxiliary magnetic field generating unit is connected to the high voltage generating unit.
